(19) United States
(12) Patent Application Publication
(10) Pub. No.: US 2020/0018354 A1
(43) Pub. Date: Jan. 16, 2020

(54) Modular Tool For Assembling And Disassembling A Joint Assembly And Method Of Operation Thereof

(71) Applicant: Dana Automotive Systems Group, LLC, Maumee, OH (US)

(72) Inventor: Johnny N. Smith, Toledo, OH (US)

(21) Appl. No.: 16/033,896

(22) Filed: Jul. 12, 2018

(51) Int. Cl. F16C 43/04; B23P 19/08; F16D 3/16

(52) U.S. Cl. CPC F16C 43/04; B23P 19/084; F16D 2250/0084; B23P 2700/11; B23P 2700/50; F16D 3/16

(57) ABSTRACT

A joint assembly and disassembly tool and method of using the tool to assemble and disassemble a joint assembly. The tool includes a first member having a first member aperture extending from a first side to a second side of the first part. Additionally, the tool includes a second member having a second member aperture extending from the first side to the second side of the second member. At least a portion of a retention member is connected to at least a portion of the first member of the tool. A first actuation mechanism is drivingly connected to a pressure plate which is received and/or retained within at least a portion of the first member aperture. Additionally, a second actuation mechanism is drivingly connected to a force application member which is selectively received within at least a portion of the second member aperture.

### FIELD OF THE DISCLOSURE

The present disclosure relates to a portable and modular tool that is used to assemble and disassemble a vehicle joint assembly.

### BACKGROUND OF THE DISCLOSURE

Various universal joint assemblies are known within the art. A conventional universal joint assembly includes a journal cross having a plurality of trunnions. Rotationally connected to each of the trunnions of the journal cross is a bearing cup assembly that is retained within an opening in a yoke arm. The conventional method of assembling a universal joint assembly includes inserting a bearing cup assembly into the opening in the yoke arm and then pressing the bearing cup assembly into the opening and over one of the trunnions of the journal cross using one tool. Once the bearing cup assembly is installed, the tool used to assemble the bearing cup onto the journal cross is unable to remove or disassemble the bearing cup assembly from the journal cross.

The conventional method of disassembling the universal joint assembly includes the use of one or more additional tools, such as an arbor press, a bottle jack and/or a sledge hammer, to force the bearing cup assembly off of the journal cross and out of the opening in the yoke arm. Additionally, the disassembly process requires the use of a torch to heat the yoke arms in order to expand the opening and force the bearing cup assembly out of the opening. This process introduces changes to the microstructure of the yoke arm, changes to the hardness of the yoke arm, changes to the overall strength of the yoke arm and introduces unwanted work hardening to the yoke arm which negatively affects the overall life and durability of the replaced and/or repaired universal joint assembly. As a result, the disassembly process for the conventional universal joint assembly is time consuming, dangerous and negatively affects the overall life and durability of the repaired and/or replaced universal joint assembly resulting in a universal joint assembly and drive shaft assembly that is unserviceable. This drastically increases the overall costs and down time associated with a damaged or failed universal joint assembly as the entire driveline assembly will have to be removed and/or replaced as opposed to just the universal joint assembly and/or the individual components of the universal joint assembly as needed.

It would therefore be advantageous to develop single tool that is capable of both assembling, disassembling and/or servicing a universal joint assembly quickly and easily without negatively affecting the overall life and durability of the various components of the universal joint assembly. Additionally, it would be advantageous to develop a single tool that modular and is capable of assembling, disassembling and/or servicing a wide array of universal joint assemblies. Furthermore, it would be advantageous to develop a single tool that is portable and capable of assembling, disassembling and servicing a wide array universal joint assemblies.

### SUMMARY OF THE DISCLOSURE

A joint assembly and disassembly tool and method of using the tool to assemble and disassemble a joint assembly. The joint assembly and disassembly tool includes a first member having a first member aperture extending from a first side to a second side of the first part. Additionally, the joint assembly and disassembly tool includes a second member having a second member aperture extending from the first side to the second side of the second member. At least a portion of a retention member is connected to at least a portion of the first member of the joint assembly and disassembly tool. A first actuation mechanism is drivingly connected to at least a portion of a pressure plate which is received and/or retained within at least a portion of the first member aperture. Additionally, a second actuation mechanism is drivingly connected to at least a portion of a force application member which is selectively received within at least a portion of the second member aperture.

According to the previous aspect of the disclosure, at least a portion of a joint assembly may be interposed between the first member and the second member of the joint assembly and disassembly tool.

According to any one of the previous aspects of the disclosure, the joint assembly may be a universal joint assembly, a U-joint assembly, a cardan joint assembly, a double cardan joint assembly, a Hooke's joint assembly, a Spicer joint assembly and/or a Hardy Spicer joint assembly.

According to any one of the previous aspects of the disclosure, the joint assembly and disassembly tool may further include one or more support members. At least a portion of the one or more support members may be connected to at least a portion of the first member and the second member of the joint assembly and disassembly tool providing a gap between the first and second members. At least a portion of the joint assembly may be disposed within at least a portion of the gap between the first and second members of the joint assembly and disassembly tool.

According to any one of the previous aspects of the disclosure, the joint assembly and disassembly tool may further include one or more hoist attachment members connected to at least a portion of one or more of the one or more support members. At least a portion of the one or more hoist attachment members may be selectively engagable with at least a portion if a hoist.

According to any one of the previous aspects of the disclosure, the joint assembly may include a yoke member having a first yoke arm with a first yoke arm aperture, a second yoke arm with a second yoke arm aperture, a journal cross and one or more bearing cup assemblies.

According to any one of the previous aspects of the disclosure, the retention member may include a first part that is disposed directly adjacent to at least a portion of a second part. A first part bearing cup receiving portion extends from a first side to a second side of the first part and inward into at least a portion of the first part from a second end of the first part of the retention member. Additionally, a second part bearing cup receiving portion extends from a first side to a second side of the second part and inward into at least a portion of the second part from a first end of the second part of the retention member. The first part bearing cup receiving portion and the second part bearing cup receiving portion may have a size and shape needed to selectively receive and/or retain at least a portion of the one or more bearing cup assemblies of the joint assembly.

According to any one of the previous aspects of the disclosure, the retention member of the joint assembly and disassembly tool may further include the use of one or more tightening members. At least a portion of the one or more tightening members may be connected to at least a portion of the first part and the second part of the retention member. Additionally, the one or more tightening members may be operably connected to at least a portion of the first part and the second part of the retention member in order to selectively drive the first part and the second part or the retention member toward and away from the one or more bearing cup assemblies of the joint assembly.

According to any one of the previous aspects of the disclosure, the joint assembly and disassembly tool may further include the use of one or more extraction members. At least a portion of the one or more extraction members may be received and/or retained within at least a portion of one or more first part extraction member apertures extending from the first side to the second side of the first part and one or more first part extraction member apertures extending from the first side to the second side of the second part of the retention member. Additionally, at least a portion of the pressure plate may be selectively engagable with at least a portion of the one or more extraction members and at least a portion of the one or more extraction members may be selectively engagable with at least a portion of the first or second yoke arm of the yoke member.

According to any one of the previous aspects of the disclosure, at least a portion of the pressure plate may be selectively engagable with the first yoke arm, the second yoke arm and/or the one or more bearing cup assemblies of the joint assembly. Additionally, at least a portion of the force application member may be selectively engagable with the first yoke arm, the second yoke arm and/or the one or more bearing cup assemblies of the joint assembly.

According to any one of the previous aspects of the disclosure, the first actuation mechanism may include a first source of rotational power, a first shaft, a first fixed cover and the pressure plate. At least a portion of the first source of rotational power may be drivingly connected to at least a portion of a first end portion of the first shaft and at least a portion of the second end portion of the first shaft may be drivingly connected to at least a portion of the pressure plate. Furthermore, at least a portion of an intermediate portion of the first shaft may be operably connected to at least a portion of the first fixed cover in order to allow the first source of rotational power to selectively drive the pressure plate toward and away from the first yoke arm, the second yoke arm and/or the one or more bearing cup assemblies of the joint assembly.

According to any one of the previous aspects of the disclosure, the second actuation mechanism may include a second source of rotational power, a second shaft, a second fixed cover and the force application member. At least a portion of the force application member may be drivingly connected to at least a portion of a first end portion of the second shaft and at least a portion of the second source of rotational power may be drivingly connected to at least a portion of a second end portion of the first shaft. Additionally, at least a portion of an intermediate portion of the second shaft may be operably connected to at least a portion of the second fixed cover in order to allow the second source of rotational power to selectively drive the force application member toward and away from the first yoke arm, the second yoke arm and/or the one or more bearing cup assemblies of the joint assembly.

According to any one of the previous aspects of the disclosure, the force application member may include a bearing cup assembly positioning portion that is disposed directly adjacent to an increased diameter portion of the force application member. The bearing cup assembly positioning portion may be of a size and shape to be received within at least a portion of the first yoke arm aperture or the second yoke arm aperture of the yoke member of the joint assembly. Additionally, the bearing cup assembly positioning portion may have a length needed to drive the one or more bearing cup assemblies into the first and/or second yoke arm aperture of the yoke member a pre-determined distance. When at least a portion of the increased diameter portion is in direct contact with at least a portion of the first yoke arm or the second yoke arm, the one or more bearing cup assemblies are in their pre-determined optimal operating positions.

A method of disassembling a joint assembly includes providing a joint assembly and disassembly tool having a first member, a second member, a retention member, a first actuation mechanism, a pressure plate, a second actuation mechanism and a force application member. Additionally, the method includes providing a first actuation mechanism having a first source of rotational power and providing a second actuation mechanism having a second source of rotational power. Furthermore, the method includes providing a joint assembly including a yoke member with a first yoke arm, a first yoke arm aperture, a second yoke arm, a second yoke arm aperture, a journal cross and one or more bearing cup assemblies. The second source of rotational power may be activated in order to apply an amount of force onto the one or more bearing cup assemblies, the first yoke arm and/or the second yoke arm with the force application member. The one or more bearing cup assemblies may then be driven into at least a portion of the retaining member thereby allowing at least a portion of the retaining member to clamp onto at least a portion of the one or more bearing cup assemblies. Once the retaining member is clamped onto the one or more baring cup assemblies, the first source of rotational power may be activated in order to apply an amount of force onto one or more extraction members by the pressure plate. This drive at least a portion of the one or more extraction members into contact with at least a portion of the first yoke arm and/or the second yoke arm of the yoke member thereby forcing the one or more bearing cup assemblies out of the first yoke arm aperture or the second yoke arm aperture of the yoke member.

According to the previous aspect of the disclosure, the method of disassembling the joint assembly may further include the step of removing one or more snap-rings or retention members from the yoke member of the joint assembly.

A method of assembling a joint assembly, including providing a joint assembly and disassembly tool having a first member, a second member, a retention member, a first actuation mechanism, a pressure plate, a second actuation mechanism and a force application member. Additionally, the method may include providing an actuation mechanism having a source of rotational power and providing a joint assembly having a yoke member with a first yoke arm, a first yoke arm aperture, a second yoke arm, a second yoke arm aperture, a journal cross and one or more bearing cup assemblies. At least a portion of the joint assembly may be disposed within at least a portion of the joint assembly and disassembly tool provided and one or more bearing cup assemblies may be inserted into at least a portion of the first yoke arm aperture and/or the second yoke arm aperture of the yoke member. The force application member may then be aligned with at least a portion of the first yoke arm, the second yoke arm, the first yoke arm aperture, the second yoke arm aperture and/or the one or more bearing cup assemblies of the joint assembly. The source of rotational power may then be activated and the one or more bearing cup assemblies may be driven into the first yoke arm aperture and/or the second yoke arm aperture of the yoke member of the joint assembly.

According to the previous aspect of the disclosure, the method of assembling the joint assembly may further include the step of installing one or more snap-rings or retention members into the first yoke arm aperture and/or the second yoke arm aperture of the yoke member of the joint assembly.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 is a schematic top plan view of a vehicle having one or more joint assemblies that may be assembled or disassembled using a joint assembly and disassembly tool according to an embodiment of the disclosure;

FIG. 2 is a schematic top plan view of another vehicle having one or more joint assemblies that may be assembled or disassembled using a joint assembly and disassembly tool according to an embodiment of the disclosure;

FIG. 3 is a schematic front view of a modular joint assembly and disassembly tool for use with a joint assembly;

FIG. 4 is a schematic front view of the modular joint assembly and disassembly tool of FIG. 3 of the disclosure illustrating a bearing cup receiving portion and a clamping member retention portion according to an embodiment of the disclosure;

FIG. 5 is a schematic front view of the modular joint assembly and disassembly tool of FIGS. 3 and 4 of the disclosure illustrating a force application member according to an embodiment of the disclosure;

FIG. 6 is a schematic front view of the clamping member of the modular joint assembly and disassembly tool illustrated in FIGS. 3-5 according to an embodiment of the disclosure;

FIG. 6A is a schematic side view of a first part of the retention member illustrated in FIG. 6 of the disclosure;

FIG. 6B is a schematic side view of a second part of the retention member illustrated in FIG. 6 of the disclosure;

FIG. 7 is a schematic front view of the modular joint assembly and disassembly tool of FIGS. 3-6A of the disclosure where a bearing cup is received within the clamping portion and/or the bearing cup receiving portion of the modular joint assembly and disassembly tool;

FIG. 8 is a schematic perspective view of a portion of the modular joint assembly and disassembly tool of FIGS. 3-7 and one or more bearing cup extraction pins of the modular joint assembly and disassembly tool according to an embodiment of the disclosure;

FIG. 9 is a schematic front view of the one or more bearing cup extraction pins of the modular joint assembly and disassembly tool illustrated in FIGS. 3-8 engaging a joint member to extract the bearing cup from the joint assembly;

FIG. 10 is a flow chart illustrating a method or process for disassembling a joint assembly according to an embodiment of the disclosure;

FIG. 11 is a schematic front view of the modular joint assembly and disassembly tool illustrated in FIGS. 3-9 assembling the bearing cup assembly into the joint assembly;

FIG. 12 is a schematic front view of the modular joint assembly and disassembly tool illustrated in FIGS. 3-9 and 11 where the bearing cup assembly is assembled within the joint assembly; and

FIG. 13 is a flow chart illustrating a method or process for assembling a joint assembly according to an embodiment of the disclosure.

### DETAILED DESCRIPTION OF THE DISCLOSURE

It is to be understood that the invention may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments of the invention disclosed are not to be considered as limiting, unless expressly stated otherwise.

It is within the scope of this disclosure, and as a non-limiting example, that the joint assembly and disassembly tool disclosed herein may be used in automotive, off-road vehicle, all-terrain vehicle, construction, structural, marine, aerospace, locomotive, military, machinery, robotic and/or consumer product applications. Additionally, as a non-limiting example, the joint assembly and disassembly tool disclosed herein may also be used in passenger vehicle, electric vehicle, hybrid vehicle, commercial vehicle, autonomous vehicles, semi-autonomous vehicles and/or heavy vehicle applications.

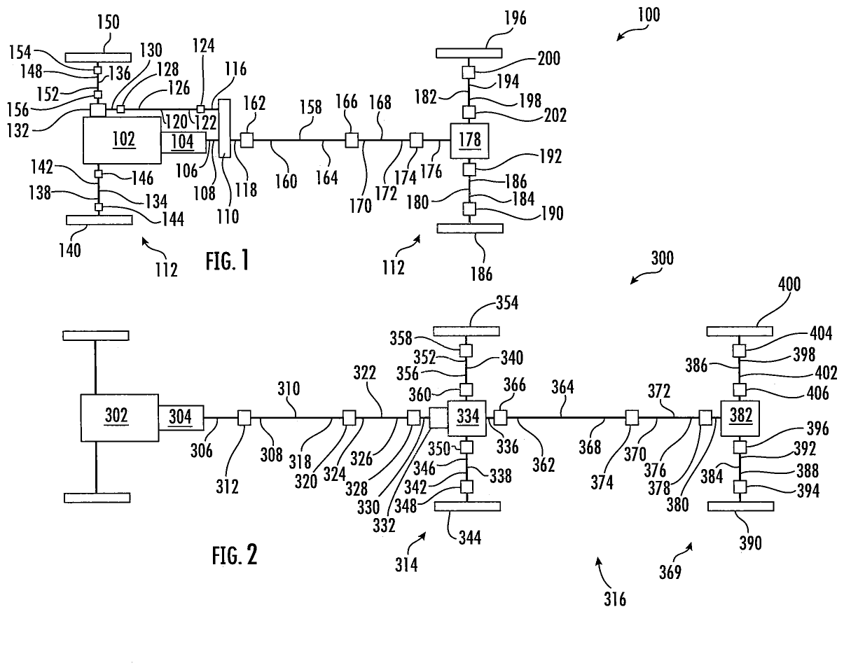

FIG. 1 is a schematic top-plan view of a vehicle 100 having one or more joint assemblies that are assembled, disassembled and/or serviced using a joint assembly and disassembly tool according to an embodiment of the disclosure. The vehicle 100 has an engine 102 which is drivingly connected to a transmission 104. A transmission output shaft 106 is then drivingly connected to an end of the transmission 104 opposite the engine 102. It is within the scope of this disclosure and as a non-limiting example that the engine 102 of the vehicle 100 may be an internal combustion engine, an electric motor, a steam turbine and/or a gas turbine. The transmission 104 is a power management system which provides controlled application of the rotational energy generated by the engine 102 by means of a gearbox.

The transmission output shaft 106 is drivingly connected to a transfer case input shaft 108 which in turn is drivingly connected to a transfer case 110. The transfer case 110 is used in four-wheel drive and/or all-wheel-drive (AWD) vehicles to transfer the rotational power from the transmission 104 to a front axle system 112 and a rear axle system 114 by utilizing a series of gears and drive shafts. Additionally, the transfer case 110 allows the vehicle 100 to selectively operate in either a two-wheel drive mode of a four-wheel/AWD drive mode. As illustrated in FIG. 1 of the disclosure and as a non-limiting example, the transfer case 110 includes a first transfer case output shaft 116 and a second transfer case output shaft 118.

A first shaft 120 extends from the first transfer case output shaft 116 toward the front axle system 112 of the vehicle 100. The first shaft 120 transmits the rotational power from the transfer case 110 to the front axle system 112 of the vehicle 100 thereby drivingly connecting the transfer case 110 to the front axle system 112. It is within the scope of this disclosure and as a non-limiting example that the first shaft 120 may be a drive shaft, a prop shaft or a Cardan shaft.

As illustrated in FIG. 1 of the disclosure and as a non-limiting example, at least a portion of a first end portion 122 of the first shaft 120 may be drivingly connected to an end of the first transfer case output shaft 116 opposite the transfer case 110 via a first joint assembly 124. Additionally, as illustrated in FIG. 1 of the disclosure and as anon-limiting example, at least a portion of a second end portion 126 of the first shaft 120 may be drivingly connected to an end of a second joint assembly 128. It is within the scope of this disclosure and as a non-limiting example that the first and/or second joint assembly 124 and/or 128 of the vehicle 100 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Drivingly connected to an end of the second joint assembly 128, opposite the first shaft 120, is a front axle input shaft 130. The front axle input shaft 130 of the vehicle 100 drivingly connects the first shaft 120 of the vehicle 100 to a front axle differential assembly 132 of the front axle system 112. In accordance with the embodiment to of the disclosure illustrated in FIG. 1 and as a non-limiting example, at least a portion of an end of the front axle system input shaft 130, opposite the first shaft 120, may be drivingly connected to at least a portion of the front axle differential assembly 132. It is within the scope of this disclosure and as a non-limiting example that the front axle input shaft 130 may be a front differential input shaft, a coupling shaft, stub shaft or a front differential pinion shaft. The front axle differential assembly 132 is a set of gears that allows the outer drive wheel(s) of the vehicle 100 to rotate at a faster rate that the inner drive wheel(s). The rotational power is transmitted through the front axle system 112 as described in more detail below.

The front axle system 112 further includes a first front axle half shaft 134 and a second front axle half shaft 136. As illustrated in FIG. 1 of the disclosure and as a non-limiting example, the first front axle half shaft 134 extends substantially perpendicular to the front axle input shaft 130 of the vehicle 100. At least a portion of a first end portion 138 of the first front axle half shaft 134 may be drivingly connected to a first front axle wheel assembly 140 and at least a portion of a second end portion 142 of the first front axle half shaft 134 may be drivingly connected to an end of the front axle differential assembly 132. It is within the scope of this disclosure and as a non-limiting example that the second end portion 142 of the first front axle half shaft 134 may be drivingly connected to a front differential side gear, a separate stub shaft, a separate coupling shaft, a first front axle differential output shaft, a first front axle half shaft connect and disconnect assembly and/or a shaft that is formed as part of a front differential side gear.

According to an embodiment of the disclosure and as a non-limiting example, at least a portion of the first end portion 138 of the first front axle half shaft 134 may be drivingly connected to an end of a third joint assembly 144. In accordance with this embodiment of the disclosure and as a non-limiting example, at least a portion of an end of the third joint assembly 144, opposite the first front axle half shaft 134, may be drivingly connected to at least a portion of the first front axle wheel assembly 140 of the vehicle 100. It is within the scope of this disclosure and as anon-limiting example that the third joint assembly 144 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with an embodiment of the disclosure and as a non-limiting example, at least a portion of the second end portion 142 of the first front axle half shaft 134 may be drivingly connected to an end of a fourth joint assembly 146. As a non-limiting example, at least a portion of an end of the fourth joint assembly 146, opposite the first front axle half shaft 134 may be drivingly connected to at least a portion of the end of the front axle differential assembly 132 of the vehicle 100. It is within the scope of this disclosure and as a non-limiting example that the fourth joint assembly 146 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that at least a portion of the end of the fourth joint assembly 146, opposite the first front axle half shaft 134, may be drivingly connected to a differential side gear, a separate stub shaft, a separate coupling shaft, a first front axle differential output shaft, a first front axle half shaft connect and disconnect assembly and/or a shaft that is formed as part of a differential side gear.

The second front axle half shaft 136 extends substantially perpendicular to the front axle system input shaft 130 of the vehicle 100. At least a portion of a first end portion 148 of the second front axle half shaft 136 may be drivingly connected to a second front axle wheel assembly 150. As illustrated in FIG. 1 of the disclosure and as a non-limiting example, at least a portion of a second end portion 152 of the second front axle half shaft 136 may be drivingly connected to an end of the front axle differential assembly 132 opposite the first front axle half shaft 134. It is within the scope of this disclosure and as a non-limiting example that the second end portion 152 of the second front axle half shaft 136 may be drivingly connected to a front differential side gear, a separate stub shaft, a separate coupling shaft, a second front axle differential output shaft, a second front axle half shaft connect and disconnect assembly and/or a shaft that is formed as part of a front differential side gear.

According to an embodiment of the disclosure and as a non-limiting example, at least a portion of the first end portion 148 of the second front axle half shaft 136 may be drivingly connected to an end of a fifth joint assembly 154. In accordance with this embodiment of the disclosure and as a non-limiting example, at least a portion of an end of the fifth joint assembly 154, opposite the second front axle half shaft 136, may be drivingly connected to at least a portion of the second front axle wheel assembly 150 of the vehicle 100. It is within the scope of this disclosure and as a non-limiting example that the fifth joint assembly 154 may be a universal joint assembly, a U-joint assembly, a cardan joint assembly, a double cardan joint assembly, a Hooke's joint assembly, a Spicer joint assembly, a homokinetic joint assembly, a constant velocity joint assembly ora Hardy Spicer joint assembly.

Additionally, in accordance with an embodiment of the disclosure and as a non-limiting example, at least a portion of the second end portion 152 of the second front axle half shaft 136 may be drivingly connected town end of a sixth joint assembly 156. As a non-limiting example, at least a portion of an end of the sixth joint assembly 156, opposite the second front axle half shaft 136, may be drivingly connected to the end of the front axle differential assembly 132 of the vehicle 100 opposite the first front axle half shaft 134. It is within the scope of this disclosure and as a non-limiting example that the sixth joint assembly 156 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that the end of the six joint assembly 156, opposite the second front axle half shaft 136, may be drivingly connected to a differential side gear, a separate stub shaft, a separate coupling shaft, a second front axle differential output shaft, a second front axle half shaft connect and disconnect assembly and/or a shaft that is formed as part of a differential side gear.

An end of the second transfer case output shaft 118 is drivingly connected to an end of the transfer case 110 opposite the transfer case input shaft 108 of the vehicle 100. A second shaft 158 extends from the second transfer case output shaft 118 toward the rear axle system 114 thereby drivingly connecting the transfer case 110 to the rear axle system 114 of the vehicle 100. As a non-limiting example, the second shaft 158 may be a drive shaft, a propeller shaft or a Cardan shaft. At least a portion of a first end portion 160 of the second shaft 158 may be drivingly connected to an end of the second transfer case output shaft 118, opposite the transfer case 110, via a seventh joint assembly 162. It is within the scope of this disclosure and as a non-limiting example that the second shaft 158 may be a drive shaft, a propeller shaft or a Cardan shaft. Additionally, it is within the scope of this disclosure and as a non-limiting example that the seventh joint assembly 162 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

As illustrated in FIG. 1 of the disclosure and as a non-limiting example, at least a portion of a second end portion 164 of the second shaft 158 may be drivingly connected to an end of an eighth joint assembly 166. It is within the scope of this disclosure and as a non-limiting example that the eighth joint assembly 166 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Drivingly connected to an end of the eighth joint assembly 166, opposite the second shaft 158, is a third shaft 168 having a first end portion 170 and a second end portion 172. At least a portion of the first end portion 170 of the third shaft 168 may be drivingly connected to an end of the eighth joint assembly 166 opposite the second shaft 158 of the vehicle 100. As best seen in FIG. 1 of the disclosure and as a non-limiting example, at least a portion of the second end portion 172 of the third shaft 168 may be drivingly connected to at least a portion of an end of a ninth joint assembly 174. It is within the scope of this disclosure and as a non-limiting example that the third shaft 168 may be a drive shaft, a propeller shaft or a Cardan shaft. Additionally, it is within the scope of this disclosure and as a non-limiting example that the ninth joint assembly 174 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

In accordance with the embodiment illustrated in FIG. 1 and as a non-limiting example, at least a portion of a rear axle system input shaft 176 may be drivingly connected to at least a portion of an end of the ninth joint assembly 174 opposite the third shaft 168. The rear axle system input shaft 176 drivingly connects the transfer case 110 the rear axle system 114 of the vehicle 100. As a non-limiting example, the rear axle system input shaft 176 may be a rear axle differential input shaft, a coupling shaft, stub shaft or a rear axle differential pinion shaft. Drivingly connected to an end of the rear axle system input shaft 176, opposite the third shaft 168, is a rear axle differential assembly 178. The rear axle differential assembly 178 is a set of gears that allows the outer drive wheel(s) of the vehicle 100 to rotate at a faster rate that the inner drive wheel(s). The rotational power is transmitted through the rear axle system 114 as described in more detail below.

As illustrated in FIG. 1 and as a non-limiting example, the rear axle system 114 further includes a first rear axle half shaft 180 and a second rear axle half shaft 182. The first rear axle half shaft 180 extends substantially perpendicular to the rear axle input shaft 176 of the vehicle 100. At least a portion of a first end portion 184 of the first rear axle half shaft 180 may be drivingly connected to a first rear axle wheel assembly 186 and at least a portion of a second end portion 188 of the first rear axle half shaft 180 may be drivingly connected to an end of the rear axle differential assembly 178. It is within the scope of this disclosure and as a non-limiting example that the second end portion 188 of the first rear axle half shaft 180 may be drivingly connected to a rear differential side gear, a separate stub shaft, a separate coupling shaft, a first rear axle differential output shaft a first rear axle half shaft connect and disconnect assembly and/or a shaft that is formed as part of a rear differential side gear.

According to an embodiment of the disclosure and as a non-limiting example, at least a portion of the first end portion 184 of the first rear axle half shaft 180 may be drivingly connected to an end of a tenth joint assembly 190. In accordance with this embodiment of the disclosure and as a non-limiting example, at least a portion of an end of the tenth joint assembly 190, opposite the first rear axle half shaft 180, may be drivingly connected to at least a portion of the first rear axle wheel assembly 186 of the vehicle 100. It is within the scope of this disclosure and as a non-limiting example that the tenth joint assembly 190 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with this embodiment of the disclosure and as a non-limiting example, at least a portion of the second end portion 188 of the first rear axle half shaft 180 may be drivingly connected to an end of an eleventh joint assembly 192. As a non-limiting example, at least a portion of an end of the eleventh joint assembly 192, opposite the first rear axle half shaft 180, may be drivingly connected to the end of the rear axle differential assembly 178 of the vehicle 100. It is within the scope of this disclosure and as a non-limiting example that the eleventh joint assembly 192 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that the end of the eleventh joint assembly 192, opposite the first rear axle half shaft 180, may be drivingly connected to a differential side gear, a separate stub shaft, a separate coupling shaft, a first rear axle differential output shaft, a first rear axle half shaft connect and disconnect assembly and/or a shaft that is formed as part of a differential side gear.

The second rear axle half shaft 182 of the vehicle 100 extends substantially perpendicular to the rear axle system input shaft 176. At least a portion of a first end portion 194 of the second rear axle half shaft 182 may be drivingly connected to a second rear axle wheel assembly 196 of the vehicle 100. As illustrated in FIG. 1 and as a non-limiting example, at least a portion of a second end portion 198 of the second rear axle half shaft 182 may be drivingly connected to an end of the rear axle differential assembly 178 opposite the first rear axle half shaft 180. It is within the scope of this disclosure and as a non-limiting example that the second end portion 198 of the second rear axle half shaft 182 may be drivingly connected to a rear differential side gear, a separate stub shaft, a separate coupling shaft, a second rear axle differential output shaft, a second rear axle half shaft connect and disconnect assembly and/or a shaft that is formed as part of a rear differential side gear.

According to an embodiment of the disclosure and as a non-limiting example, at least a portion of the first end portion 194 of the second rear axle half shaft 182 may be drivingly connected to an end of a twelfth joint assembly 200. In accordance with this embodiment of the disclosure and as a non-limiting example, at least a portion of an end of the twelfth joint assembly 200, opposite the second rear axle half shaft 182, may be drivingly connected to at least a portion of the second rear axle wheel assembly 196 of the vehicle 100. It is within the scope of this disclosure and as a non-limiting example that the twelfth joint assembly 200 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with this embodiment of the disclosure and as a non-limiting example, at least a portion of the second end portion 198 of the second rear axle half shaft 182 may be drivingly connected to an end of a thirteenth joint assembly 202 of the vehicle 100. As a non-limiting example, at least a portion of an end of the thirteenth joint assembly 202, opposite the second rear axle half shaft 182, may be drivingly connected to the end of the rear axle differential assembly 178 opposite the first rear axle half shaft 180. It is within the scope of this disclosure and as a non-limiting example that the thirteenth joint assembly 202 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that the end of the thirteenth joint assembly 202, opposite the second rear axle half shaft 182, may be drivingly connected to a differential side gear, a separate stub shaft, a separate coupling shaft, a second rear axle differential output shaft, a second rear axle half shaft connect and disconnect assembly and/or a shaft that is formed as part of a differential side gear.

It is within the scope of this disclosure and as a non-limiting example that one or more of the joint assemblies 124, 128, 144, 146, 154, 156, 162, 166, 174, 190, 192, 200 and/or 202 of the vehicle 100 may be assembled, disassembled and/or serviced using a joint assembly and disassembly tool according to an embodiment of the disclosure.

FIG. 2 is a schematic top-plan view another vehicle 300 having one or more joint assemblies that are assembled, disassembled and/or services using a joint assembly and disassembly tool according to an embodiment of the disclosure. The vehicle 300 has an engine 302 which is drivingly connected to a transmission 304. As non-limiting example, the engine 302 of the vehicle 300 may be an internal combustion engine, an electric motor, a steam turbine and/or a gas turbine. A transmission output shaft 306 is then drivingly connected to an end of the transmission 304 opposite the engine 302 of the vehicle 300. As previously discussed in relation to FIG. 1, the transmission 304 is a power management system which provides controlled application of the rotational energy generated by the engine 302 by means of a gearbox.

Drivingly connected to an end of the transmission output shaft 306, opposite the transmission 304 may be drivingly connected a first end portion 308 of a first shaft 310 via a first joint assembly 312. The first shaft 310 extends from the transmission 304 toward a forward tandem axle system 314 of a tandem axle system 316 of the vehicle 300. It is within the scope of this disclosure and as a non-limiting example that the first shaft 310 may be a drive shaft, a propeller shaft or a Cardan shaft. Additionally, it is within the scope of this disclosure and as a non-limiting example that the first joint assembly 312 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

As illustrated in FIG. 2 of the disclosure and as a non-limiting example, at least a portion of a second end portion 318 of the first shaft 310 may be drivingly connected to an end of a second joint assembly 320. It is within the scope of this disclosure and as a non-limiting example that the second joint assembly 468 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Drivingly connected to an end of the second joint assembly 320, opposite the first shaft 310, is a second shaft 322 having a first end portion 324 and a second end portion 326. At least a portion of the first end portion 324 of the second shaft 322 may be drivingly connected to an end of the second joint assembly 320 opposite the first shaft 310 of the vehicle 300. As illustrated in FIG. 2 and as a non-limiting example, at least a portion of the second end portion 326 of the second shaft 322 may be drivingly connected to at least a portion of an end of a third joint assembly 328. It is within the scope of this disclosure and as a non-limiting example that the second shaft 322 may be a drive shaft, a propeller shaft or a Cardan shaft. Additionally, it is within the scope of this disclosure and as a non-limiting example that the third joint assembly 328 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

In accordance with the embodiment illustrated in FIG. 1 and as a non-limiting example, an end of the third joint assembly 328, opposite the second shaft 322, may be drivingly connected at least a portion of an end a forward tandem axle input shaft 330. As a non-limiting example, the forward tandem axle input shaft 330 may be a forward tandem axle differential input shaft, a coupling shaft, stub shaft, a forward tandem axle differential pinion shaft, an inter-axle differential input shaft or an inter-axle differential pinion shaft. Drivingly connected to an end of the forward tandem axle input shaft 330, opposite the second shaft 322, is an inter-axle differential assembly 332 of the forward tandem axle system 314 of the vehicle 300. The inter-axle differential assembly 332 is a device that divides the rotational power generated by the engine 302 between the axles in the vehicle 300. The rotational power is transmitted through the forward tandem axle system 314 as described in more detail below.

As best seen in FIG. 2 and as a non-limiting example, the inter-axle differential assembly 332 of the vehicle 300 is drivingly connected to a forward tandem axle differential assembly 334 and a forward tandem axle system output shaft 336. The forward tandem axle differential assembly 334 is a set of gears that allows the outer drive wheel(s) of the vehicle 400 to rotate at a faster rate than the inner drive wheel(s).

The forward tandem axle system 314 of the vehicle 300 further includes a first forward tandem axle half shaft 338 and a second forward tandem axle half shaft 340. As illustrated in FIG. 2 and as a non-limiting example, the first forward tandem axle half shaft 338 extends substantially perpendicular to the forward tandem axle input shaft 330 of the vehicle 300. At least a portion of a first end portion 342 of the first forward tandem axle half shaft 338 may be drivingly connected to at least a portion of a first forward tandem axle wheel assembly 344 and at least a portion of a second end portion 346 of the first forward tandem axle half shaft 338 may be drivingly connected to an end of the forward tandem axle differential assembly 334. It is within the scope of this disclosure and as a non-limiting example that the second end portion 346 of the first forward tandem axle half shaft 338 may be drivingly connected to a forward tandem axle differential side gear, a separate stub shaft, a separate coupling shaft, a first forward tandem axle differential output shaft, a first forward tandem axle half shaft connect and disconnect assembly and/or a shaft that is formed as part of a forward tandem axle differential side gear.

According to an embodiment of the disclosure and as a non-limiting example, at least a portion of the first end portion 342 of the first forward tandem axle half shaft 338 may be drivingly connected to at least a portion of an end of a fourth joint assembly 348. In accordance with this embodiment of the disclosure and as a non-limiting example, at least a portion of an end of the fourth joint assembly 348, opposite the first forward tandem axle half shaft 338, may be drivingly connected to at least a portion of the first forward tandem axle wheel assembly 344 of the vehicle 300. It is within the scope of this disclosure and as a non-limiting example that the fourth joint assembly 348 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with an embodiment of the disclosure and as a non-limiting example, at least a portion of the second end portion 346 of the first forward tandem axle half shaft 338 may be drivingly connected to at least a portion of an end of a fifth joint assembly 350. As a non-limiting example, at least a portion of an end of the fifth joint assembly 350, opposite the first forward tandem axle half shaft 338, may be drivingly connected to the end of the forward tandem axle differential assembly 334 of the vehicle 300. It is within the scope of this disclosure and as a non-limiting example that the fifth joint assembly 350 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that at least a portion of the end of the fifth joint assembly 350, opposite the first forward tandem axle half shaft 338, may be drivingly connected to a forward tandem axle differential side gear, a separate stub shaft, a separate coupling shaft, a first forward tandem axle differential output shaft, a first forward tandem axle half shaft connect and disconnect assembly and/or a shaft that is formed as part of a forward tandem axle differential side gear.

The second forward tandem axle half shaft 340 extends substantially perpendicular to the forward tandem axle input shaft 330 of the vehicle 300. At least a portion of a first end portion 352 of the second forward tandem axle half shaft 340 may be drivingly connected to at least a portion of a second forward tandem axle wheel assembly 354 of the vehicle 300. As illustrated in FIG. 2 of the disclosure and as a non-limiting example, at least a portion of a second end portion 356 of the second forward tandem axle half shaft 340 may be drivingly connected to an end of the forward tandem axle differential assembly 334 opposite the first forward tandem axle half shaft 338. It is within the scope of this disclosure and as a non-limiting example that the second end portion 356 of the second forward tandem axle half shaft 340 may be drivingly connected to a forward tandem axle differential side gear, a separate stub shaft, a separate coupling shaft, a second forward tandem axle differential output shaft, a second forward tandem axle half shaft connect and disconnect assembly and/or a shaft that is formed as part of a forward tandem axle differential side gear.

According to an embodiment of the disclosure and as a non-limiting example, at least a portion of the first end portion 352 of the second forward tandem axle half shaft 340 may be drivingly connected to at least a portion of an end of a sixth joint assembly 358. In accordance with this embodiment of the disclosure and as a non-limiting example, at least a portion of an end of the sixth joint assembly 358, opposite the second forward tandem axle half shaft 340, may be drivingly connected to at least a portion of the second forward tandem axle wheel assembly 354 of the vehicle 300. It is within the scope of this disclosure and as a non-limiting example that the sixth joint assembly 358 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with as embodiment of the disclosure and as a non-limiting example, at least a portion of the second end portion 356 of the second forward tandem axle half shaft 340 may be drivingly connected to at least a portion of an end of a seventh joint assembly 360. As a non-limiting example, at least a portion of an end of the seventh joint assembly 360, opposite the second forward tandem axle half shaft 340, may be drivingly connected to the end of the forward tandem axle differential assembly 334 opposite the first forward tandem axle half shaft 338 of the vehicle 300. It is within the scope of this disclosure and as a non-limiting example that the seventh joint assembly 360 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that at least a portion of the end of the seventh joint assembly 360, opposite the second forward tandem axle half shaft 340, may be drivingly connected to a forward tandem axle differential side gear, a separate stub shaft, a separate coupling shaft, a second forward tandem axle differential output shaft, a second forward tandem axle half shaft connect and disconnect assembly and/or a shaft that is formed as part of a forward tandem axle differential side gear.

One end of the forward tandem axle system output shaft 336 may be drivingly connected to a side of the inter-axle differential assembly 332 opposite the forward tandem axle input shaft 330. An end of the forward tandem axle system output shaft 336, opposite the inter-axle differential assembly 332, may be drivingly connected to a first end portion 362 of a third shaft 364 via an eighth joint assembly 366. The third shaft 364 extends from the forward tandem axle system output shaft 336 toward a rear tandem axle system 369 of the tandem axle system 316 of the vehicle 300. It is within the scope of this disclosure and as a non-limiting example, that the third shaft 364 may be a drive shaft, a propeller shaft or a Cardan shaft. Additionally, it is within the scope of this disclosure and as a non-limiting example that the eighth joint assembly 366 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

At least a portion of a second end portion 368 of the third shaft 364 may be drivingly connected to at least a portion of a first end portion 370 of a fourth shaft 372 via a ninth joint assembly 374. The fourth shaft 372 extends from an end of the ninth joint assembly 374, opposite the third shaft 364, toward the rear axle system 369 of the vehicle 300. Drivingly connected to at least a portion of a second end portion 376 of the fourth shaft 372 is a tenth joint assembly 378. It is within the scope of this disclosure and as a non-limiting example that the fourth shaft 372 may be a drive shaft, a propeller shaft or a Cardan shaft. Additionally, it is within the scope of this disclosure and as a non-limiting example that the ninth and/or the tenth joint assembly 374 and/or 378 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Drivingly connected to an end of the tenth joint assembly 378, opposite the fourth shaft 372, is an end of rear tandem axle system input shaft 380. The rear tandem axle system input shaft 380 drivingly connects the inter-axle differential assembly 332 to a rear tandem axle differential assembly 382 of the rear tandem axle system 368 of the vehicle 300. As a non-limiting example, the rear tandem axle system input shaft 380 may be a rear tandem axle differential input shaft, a coupling shaft, stub shaft or a rear tandem axle differential pinion shaft. At least a portion of an end of the rear tandem axle system input shaft 380, opposite the fourth shaft 372, may be drivingly connected to at least a portion of the rear tandem axle differential assembly 382. The rear tandem axle differential assembly 382 is a set of gears that allows the outer drive wheel(s) of the vehicle 300 to rotate at a faster rate that the inner drive wheel(s). The rotational power is transmitted through the rear tandem axle system 369 as described in more detail below.

The rear tandem axle system 369 of the vehicle 300 further includes a first rear tandem axle half shaft 384 and a second rear tandem axle half shaft 386. As illustrated in FIG. 2 of the disclosure and as a non-limiting example, the first rear tandem axle half shaft 384 extends substantially perpendicular to the rear tandem axle input shaft 380 of the vehicle 300. At least a portion of a first end portion 388 of the first rear tandem axle half shaft 384 may be drivingly connected to at least a portion of a first rear tandem axle wheel assembly 390 and at least a portion of a second end portion 392 of the first rear tandem axle half shaft 384 may be drivingly connected to an end of the rear tandem axle differential assembly 382. It is within the scope of this disclosure and as a non-limiting example that the second end portion 392 of the first rear tandem axle half shaft 384 may be drivingly connected to a rear tandem axle differential side gear, a separate stub shaft, a separate coupling shaft, a first rear tandem axle differential output shaft, a first rear tandem axle half shaft connect and disconnect assembly and/or a shaft that is formed as part of a rear tandem axle differential side gear.

According to an embodiment of the disclosure and as a non-limiting example, at least a portion of the first end portion 388 of the first rear tandem axle half shaft 384 may be drivingly connected to at least a portion of an end of an eleventh joint assembly 394. In accordance with this embodiment of the disclosure and as a non-limiting example, at least a portion of an end of the eleventh joint assembly 394, opposite the first rear tandem axle half shaft 384, may be drivingly connected to at least a portion of the first rear tandem axle wheel assembly 390 of the vehicle 300. It is within the scope of this disclosure and as a non-limiting example that the eleventh joint assembly 394 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with an embodiment of the disclosure and as a non-limiting example, at least a portion of the second end portion 392 of the first rear tandem axle half shaft 384 may be drivingly connected to at least a portion of an end of a twelfth joint assembly 396. As a non-limiting example, at least a portion of an end of the twelfth joint assembly 396, opposite the first rear tandem axle half shaft 384, may be drivingly connected to the end of the rear tandem axle differential assembly 382. It is within the scope of this disclosure and as a non-limiting example that the twelfth joint assembly 396 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that at least a portion of the end of the twelfth joint assembly 396, opposite the first rear tandem axle half shaft 384, may be drivingly connected to a rear tandem axle differential side gear, a separate stub shaft, a separate coupling shaft, a first rear tandem axle differential output shaft, a first rear tandem axle half shaft connect and disconnect assembly and/or a shaft that is formed as part of a rear tandem axle differential side gear.

The second rear tandem axle half shaft 386 extends substantially perpendicular to the rear tandem axle input shaft 380 of the vehicle 300. At least a portion of a first end portion 398 of the second rear tandem axle half shaft 386 may be drivingly connected to at least a portion of a second rear tandem axle wheel assembly 400. As illustrated in FIG. 2 and as a non-limiting example, at least a portion of a second end portion 402 of the second rear tandem axle half shaft 386 may be drivingly connected to an end of the rear tandem axle differential assembly 382 opposite the first rear tandem axle half shaft 384. It is within the scope of this disclosure and as a non-limiting example that the second end portion 402 of the second rear tandem axle half shaft 386 may be drivingly connected to a rear tandem axle differential side gear, a separate stub shaft, a separate coupling shaft, a second rear tandem axle differential output shaft, a second rear tandem axle half shaft connect and disconnect assembly and/or a shaft that is formed as part of a rear tandem axle differential side gear.

According to an embodiment of the disclosure and as a non-limiting example, at least a portion of the first end portion 398 of the second rear tandem axle half shaft 386 may be drivingly connected to at least a portion of an end of a thirteenth joint assembly 404. In accordance with this embodiment of the disclosure and as a non-limiting example, at least a portion of an end of the thirteenth joint assembly 404, opposite the second rear tandem axle half shaft 386, may be drivingly connected to at least a portion of the second rear tandem axle wheel assembly 400 of the vehicle 300. It is within the scope of this disclosure and as a non-limiting example that the thirteenth joint assembly 404 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly.

Additionally, in accordance with an embodiment of the disclosure and as a non-limiting example, at least a portion of the second end portion 402 of the second rear tandem axle half shaft 386 may be drivingly connected to at least a portion of an end of a fourteenth joint assembly 406. As a non-limiting example, at least a portion of an end of the fourteenth joint assembly 406, opposite the second rear tandem axle half shaft 386, may be drivingly connected to the end of the rear tandem axle differential assembly 382 opposite the first rear tandem axle half shaft 384. It is within the scope of this disclosure and as a non-limiting example that the fourteenth joint assembly 406 may be a universal joint assembly, a U-joint assembly, a cardan joint assembly, a double cardan joint assembly, a Hooke's joint assembly, a Spicer joint assembly, a homokinetic joint assembly, a constant velocity joint assembly or a Hardy Spicer joint assembly. Additionally, it is within the scope of this disclosure and as a non-limiting example that at least a portion of the end of the fourteenth joint assembly 406, opposite the second rear tandem axle half shaft 386, may be drivingly connected to a rear tandem axle differential side gear, a separate stub shaft, a separate coupling shaft, a second rear tandem axle differential output shaft, a second rear tandem axle half shaft connect and disconnect assembly and/or a shaft that is formed as part of a rear tandem axle differential side gear.

It is within the scope of this disclosure and as a non-limiting example that one or more of the joint assemblies 312, 320, 328, 348, 350, 358, 360, 366, 374, 378, 394, 396, 404 and/or 406 of the vehicle 300 may be assembled, disassembled and/or serviced using a joint assembly and disassembly tool according to an embodiment of the disclosure.

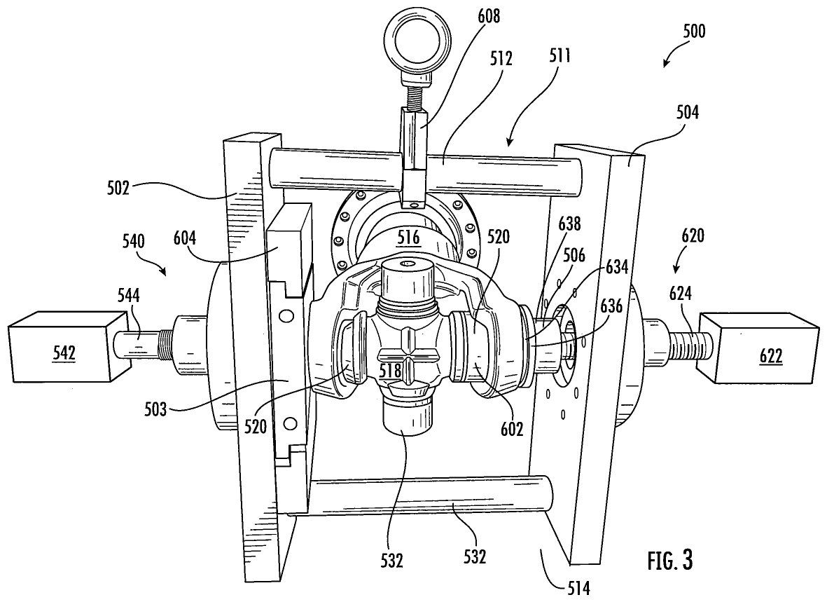

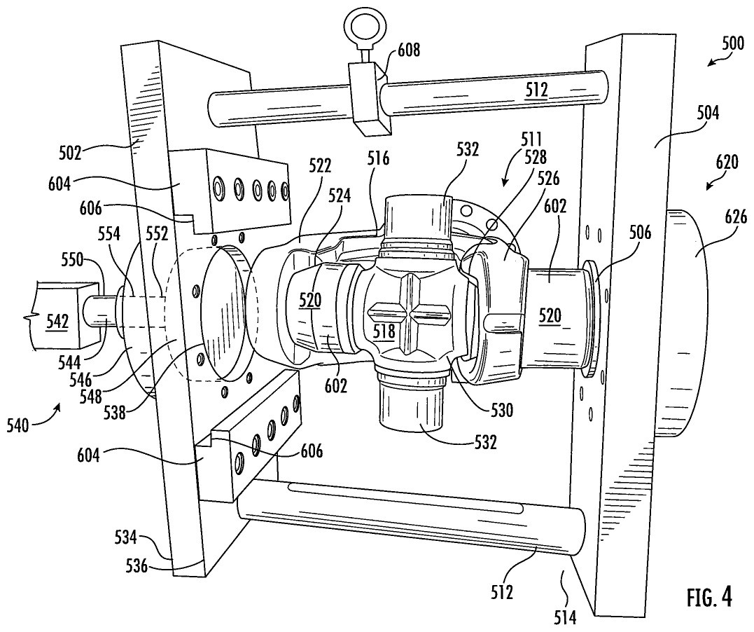

FIGS. 3-9 provide a schematic illustration of a joint assembly and disassembly tool 500 according to an embodiment of the disclosure. As illustrated in FIGS. 3-9 of the disclosure and as a non-limiting example, the joint assembly and disassembly tool 500 may include a first member 502, a second member 504, a force application member 506, a retention member 508 and one or more extraction members 510. The joint assembly and disassembly tool 500 illustrated in FIGS. 3-9 of the disclosure may be used in order to assemble, disassemble and/or service one or more joint assemblies 511 of a vehicle (not shown). It is within the scope of this disclosure and as a non-limiting example that the one or more joint assemblies 511 may be one or more universal joint assemblies, one or more U-joint assemblies, one or more cardan joint assemblies, one or more double cardan joint assemblies, one or more Hooke's joint assemblies, one or more Spicer joint assemblies and/or one or more Hardy Spicer joint assemblies.

At least a portion of the first member 502 may be integrally connected to at least a portion of the second member 504 of the joint assembly and disassembly tool 500 by using one or more support members 512. The one or more support portions 512 provide structural rigidity to the joint assembly and disassembly tool 500 and provide a space or gap 514 between the first and second members 502 and 504 of the joint assembly and disassembly tool 500. It is within the scope of this disclosure and as a non-limiting example that the one or more support members 512 may be adjustable in order to increase or decrease the space or gap 514 between the first and second members 502 and 504 of the joint assembly and disassembly tool 500 as needed to fit any desired application. As a result, it is to be understood that the joint assembly and disassembly tool 500 may be modular in nature allowing it to be used in a wide array of potential application.

Disposed within at least a portion of the space or gap 514 between the first member 502 and the second member 504 of the joint assembly and disassembly tool 500 is the one or more joint assemblies 511. As best seen in FIG. 3 of the disclosure and as a non-limiting example, the one or more joint assemblies 511 may include a yoke member 516, a journal cross 518 and a plurality of bearing cup assemblies 520. The yoke member 516 of the joint assembly 511 includes a first yoke arm 522 with a first yoke arm aperture 524 and a second yoke arm 526 with a second yoke arm aperture 528.

Extending outward from at least a portion of a body portion 530 of the journal cross 518 of the joint assembly 511 is a plurality of trunnions 532. At least a portion of one of the plurality of bearing cup assemblies 520 of the joint assembly 511 are disposed outboard from, and rotationally connected to, at least a portion of each of the plurality of trunnions 532 of the joint assembly 511. Additionally, when assembles, at least a portion of the one or more bearing cup assemblies 520 is received and/or retained within at least a portion of the first and second yoke arm apertures 524 and 528 of the yoke member 516. This provides a driving connection between the yoke member 516 and the journal cross 518 of the joint assembly 511.

In accordance with an embodiment of the disclosure (not shown) and as a non-limiting example, the joint assembly 511 may further include the use of one or more retaining members (not shown). At least a portion of the one or more retaining members (not shown) may be received and/or retained within at least a portion of the first and second yoke arm apertures 524 and 528 in order to prevent the plurality of bearing cup assemblies 520 from exiting the first and second yoke arm apertures 524 and 528 when in operation.

As best seen in FIG. 4 of the disclosure and as a non-limiting example, the first member 502 of the joint assembly and disassembly tool 500 has a first side 534 and a second side 536. Extending from the first side 534 to the second side 536 of the first member 502 is a first member aperture 538. The first member aperture 538 of first member 502 of the joint assembly and disassembly tool 500 may be of a size and shape to receive and/or retain at least a portion of a first actuation mechanism 540. It is within the scope of this disclosure and as a non-limiting example that the first actuation mechanism 540 of the joint assembly and disassembly tool 500 may be a linear actuation mechanism, a mechanical actuation mechanism, a lead-screw actuation mechanism, a roller screw actuation mechanism, a screw jack actuation mechanism, a ball screw actuation mechanism, a linear electric actuation mechanism, a linear hydraulic actuation mechanism and/or a pneumatic linear actuation mechanism.

According to the embodiment illustrated in FIGS. 3, 4, 7, 8 and 9 of the disclosure and as a non-limiting example, the first actuation mechanism 540 may include a first source of rotational power 542, a first shaft member 544, a first fixed cover 546 and a pressure plate 548. At least a portion of a first end portion 550 of the first shaft member 544 may be drivingly connected to at least a portion of the first source of rotational power 542 and at least a portion of a second end portion 552 of the first shaft member 544 may be drivingly connected to at least a portion of an end of the pressure plate 548 of the first actuation mechanism 540. Additionally, at least a portion of an intermediate portion 554 of the first shaft member 544 of the first actuation mechanism 540 may be engaged with at least a portion of the first fixed cover 546 which is integrally connected to at least a portion of the first side 534 of the first member 502 of the joint assembly and disassembly tool 500. It is therefore to be understood that the rotational power generated by the first source of rotational power 542 is translated in a linear manner to the pressure plate 548 through the first shaft member 544. This thrusts or plunges the pressure plate 548 within the first member aperture 538 toward and away from the one or more extraction members 510 and/or the one or more bearing cup assemblies 520 within the yoke arm aperture 524 or 528 of the yoke member 516. As a result, the pressure plate 548 may be configured in order to apply a substantially equal amount of force onto the one or more extraction members 510 of the joint assembly and disassembly tool 500. It is within the scope of this disclosure and as a non-limiting example that the first fixed cover 546 may be integrally foamed as part of the first member 502 of the joint assembly and disassembly tool 500 or integrally connected to at least a portion of the first side 534 of the first member 502 by using one or more welds, one or more adhesives, one or more mechanical fasteners, a spline connection and/or a threaded connection. Additionally, it is within the scope of this disclosure and as a non-limiting example that the first source of rotational power 542 may be an electric motor, a pneumatic tool, an impact tool, a socket wrench tool, a wrench, an impactor, an impact wrench, an air wrench, an impact gun, a rattle gun, a torque gun and/or a windy gun.

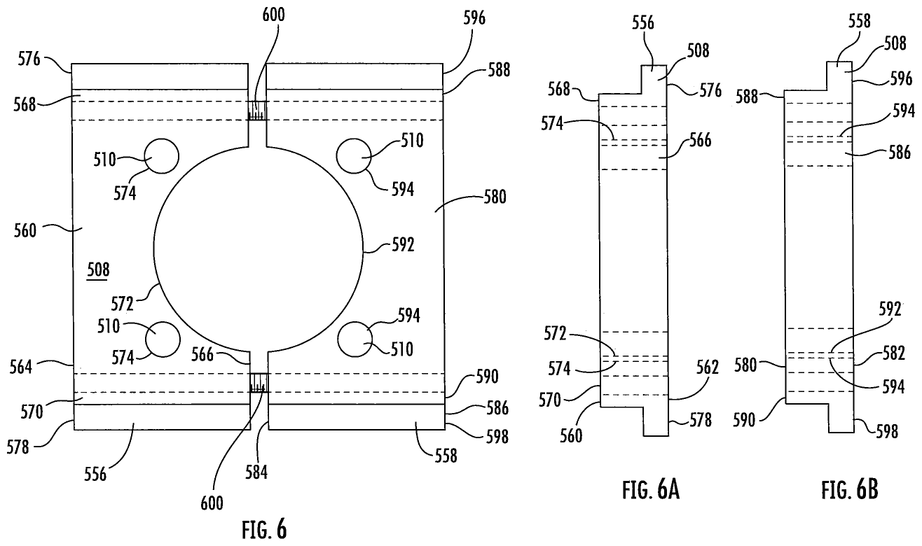

Disposed outboard form and directly adjacent to at least a portion of the second side 536 of the first member 502 of the joint assembly and disassembly tool 500 is the retention member 508. As best seen in FIG. 6 of the disclosure and as a non-limiting example, the retention member 508 may include a first part 556 and a second part 558. The first part 556 of the retention member 508 has a first side 560, a second side 562, a first end 564, a second end 566, a top portion 568 and a bottom portion 570. Extending from the first side 560 to the second side 562 and inward into at least a portion of the first part 556 of the retention member 508, from the second end 566 of the first part 556, is a first part bearing cup receiving portion 572. At least a portion of the first part bearing cup receiving portion 572 of the first part 556 of the retention member 508 is aligned with the yoke arm aperture 524 or 528 of the yoke member 516 and/or the first member aperture 538 of first member 502 of the joint assembly and disassembly tool 500. It is within the scope of this disclosure and as a non-limiting example that the first part bearing cup receiving portion 572 may have a semi-circular shape or a half circle shape.

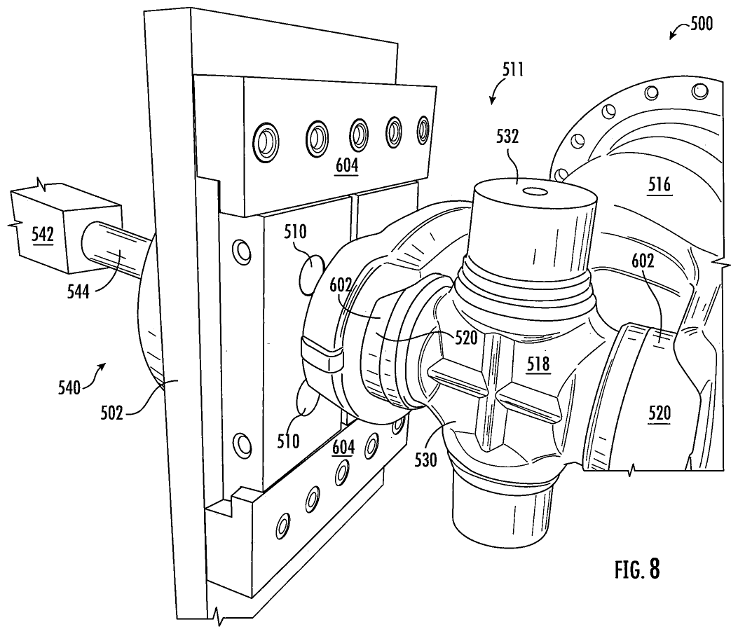

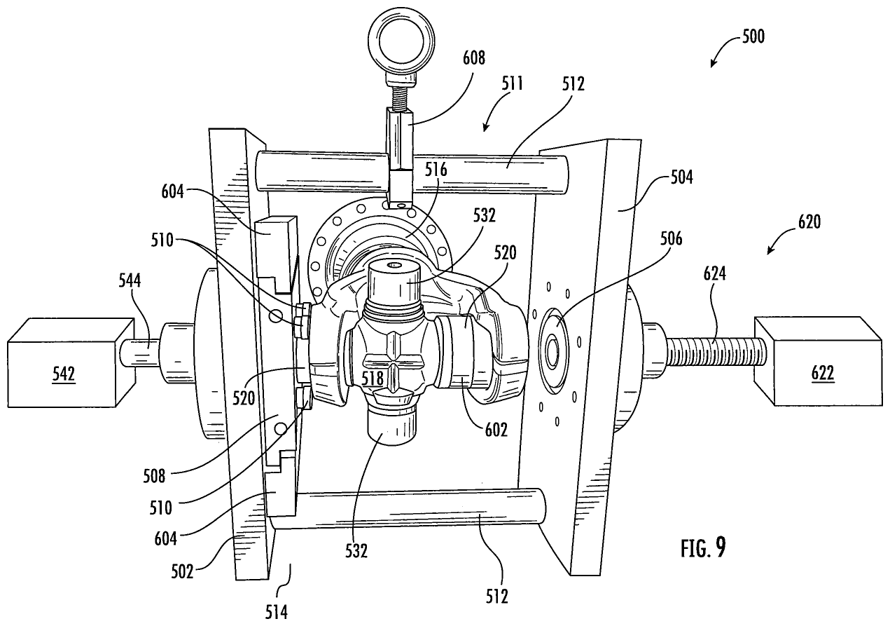

One or more first part extraction member apertures 574 may extend from the first side 560 to the second side 562 of the first part 556 of the retention member 508. The one or more first part extraction member apertures 574 may be of a size and shape to receive and/or retain at least a portion of the one or more extraction members 510 of the joint assembly and disassembly tool 500. As best seen in FIG. 6 of the disclosure and as a non-limiting example, the one or more first part extraction member apertures 574 are disposed outboard from and directly adjacent to the first part bearing cup receiving portion 572 in the first part 556 of the retention member 508. Additionally, as best seen in FIGS. 8 and 9 and as a non-limiting example, the one or more first part extraction member apertures 574, and therefore the one or more extraction members 510, are spaced in such a way that at least a portion of the one or more extraction members 510 may selectively come into direct contact with the first or second yoke arm 522 or 526 of the yoke member 516.

In accordance with the embodiment illustrated in FIGS. 6 and 6A of the disclosure and as a non-limiting example, the first part 556 of the retention member 508 may include a first protruding portion 576 and a second protruding portion 578. The first and second protruding portions 576 and 578 of the of the first part 556 of the retention member 508 aid in securing and/or attaching the retention member 508 to at least a portion of the second side 536 of the joint assembly and disassembly tool 500. As best seen in FIGS. 6 and 6A of the disclosure and as a non-limiting example, at least a portion of the first protruding portion 576 extends outward from at least a portion of the top portion 568 of the first part 556 of the retention member 508. Additionally, as best seen in FIGS. 6 and 6A of the disclosure and as a non-limiting example, at least a portion of the second protruding portion 578 may extend outward from at least a portion of the bottom portion 570 of the first part 556 of the retention member 508.

The second part 558 of the retention member 508 has a first side 580, a second side 582, a first end 584, a second end 586, a top portion 588 and a bottom portion 590. Extending from the first side 580 to the second side 582 and inward into at least a portion of the second part 558 of the retention member 508, from the first end 584 of the second part 558, is a second part bearing cup receiving portion 592. At least a portion of the second part bearing cup receiving portion 592 of the second part 558 of the retention member 508 is aligned with the yoke arm aperture 524 or 528 of the yoke member 516 and/or the first member aperture 538 of first member 502 of the joint assembly and disassembly tool 500. As best seen in FIG. 6 of the disclosure and as a non-limiting example, when the retention member 508 is assembled, at least a portion of the first part bearing cup receiving portion 572 is disposed directly adjacent to at least a portion of the second part bearing cup receiving portion 592. It is within the scope of this disclosure and as a non-limiting example that the second part bearing cup receiving portion 592 may have a semi-circular shape or a half circle shape. As a result, the first part bearing cup receiving portion 572 and the second part bearing cup receiving portion 592 may be of a size and shape to receive and/or retain at least a portion of the one or more bearing cup assemblies 520 of the joint assembly 511.

One or more second part extraction member apertures 594 may extend from the first side 580 to the second side 582 of the second part 558 of the retention member 508. The one or more second part extraction member apertures 594 may be of a size and shape to receive and/or retain at least a portion of the one or more extraction members 510 of the joint assembly and disassembly tool 500. As best seen in FIG. 6 of the disclosure and as a non-limiting example, the one or more second part extraction member apertures 594 are disposed outboard from and directly adjacent to the second part bearing cup receiving portion 592 in the second part 558 of the retention member 508. Additionally, as best seen in FIGS. 8 and 9 and as a non-limiting example, the one or more second part extraction member apertures 594, and therefore the one or more extraction members 510, are spaced in such a way that at least a portion of the one or more extraction members 510 may selectively come into direct contact with the first or second yoke arm 522 or 526 of the yoke member 516.

In accordance with the embodiment illustrated in FIGS. 6 and 6B and as a non-limiting example, the second part 558 of the retention member 508 may include a third protruding portion 596 and a fourth protruding portion 598. The first and second protruding portions 596 and 598 of the of the second part 558 of the retention member 508 aid in securing and/or attaching the retention member 508 to at least a portion of the second side 536 of the joint assembly and disassembly tool 500. As best seen in FIGS. 6 and 6B and as a non-limiting example, at least a portion of the third protruding portion 596 extends outward from at least a portion of the top portion 588 of the second part 558 of the retention member 508. Additionally, as best seen in FIGS. 6 and 6B of the disclosure and as a non-limiting example, at least a portion of the fourth protruding portion 598 may extend outward from at least a portion of the bottom portion 590 of the second part 558 of the retention member 508.

At least a portion of the first part 556 and the second part 558 of the retention member 508 of the joint assembly and disassembly tool 500 may be integrally connected to each other via one or more tightening members 600. The one or more tightening members 600 may be operably connected to at least a portion of the first and second parts 556 and 558 of the retention member 508 in order to selectively drive the first and second parts 556 and 558 toward and away from each other. As a result, it is to be understood that the one or more tightening members 600 may be operable configured in order to selectively drive the first and second parts 556 and 558 into and out of engagement with the one or more bearing cup assemblies 520. This allows the retention member 508 of the joint assembly and disassembly tool 500 to selectively grasp and/or securely attach to an outer surface 602 of the one or more bearing cup assemblies 520 when in operation. It is within the scope of this disclosure and as a non-limiting example, that the one or more tightening members 600 may be one or more screw members, one or more biasing members, one or more pneumatic members and/or one or more hydraulic members.

The first member 502 of the joint assembly and disassembly tool 500 may further include the use of one or more retention member attachment portions 604. In accordance with the embodiment illustrated in FIG. 4 of the disclosure and as a non-limiting example, the one or more retention member attachment portions 604 may include one or more retention member receiving grooves 606 extending inward into the one or more retention member attachment portions 604. The one or more retention member receiving grooves 606 may be of a size and shape to receive and/or retain at least a portion of the first, second, third and fourth protruding portions 576, 578, 596 and 598 of the first and second parts 556 and 558 of the retention member 508. As a result, this securely attaches at least a portion of the retention member 508 to the second side 536 of the first member 502 of the joint assembly and disassembly tool 500. It is within the scope of this disclosure and as a non-limiting example that the more retention member attachment portions 604 may be integrally formed as part of the second side 536 of the first member 502 or integrally connected to at least a portion of the second side 536 of the first member 502 by using one or more welds, one or more mechanical fasteners, one or more adhesives, an attachment groove connection, a spline connection and/or a threaded connection.

By making the retention member 508 and/or the retention member attachment portions 604 separable from the joint assembly and disassembly tool 500 it allows the joint assembly and disassembly tool 500 to be modular allowing it to be used to assemble, disassemble and/or service a wide array of joint assemblies 511. This may be achieved by simply attaching a retention member having bearing cup receiving portions matching she shape of the one or more bearing cup assemblies to the joint assembly and disassembly tool 500. As a result, it is to be understood that the joint assembly and disassembly tool 500 may be customizable allowing it to be utilized in the assembly, disassembly and/or service of a wide array of joint assemblies 511 having varying sizes and shapes.

According to an embodiment of the disclosure and as a non-limiting example, one or more hoist attachment members 608. In accordance with the embodiment illustrated in FIGS. 3, 4, 7 and 9 of the disclosure and as a non-limiting example, at least a portion of the one or more hoist attachment members 608 may be integrally connected to at least a portion of the one or more support portions 512 of the joint assembly and disassembly tool 500. It is within the scope of this disclosure and as a non-limiting example that the one or more hoist attachment members 608 may be integrally formed as part of one or more of the one or more support members 512 or integrally connected to at least a portion of one or more of the one or more support members 512 by using one or more welds, one or more mechanical fasteners, one or more adhesives, a spline connection and/or a threaded connection.

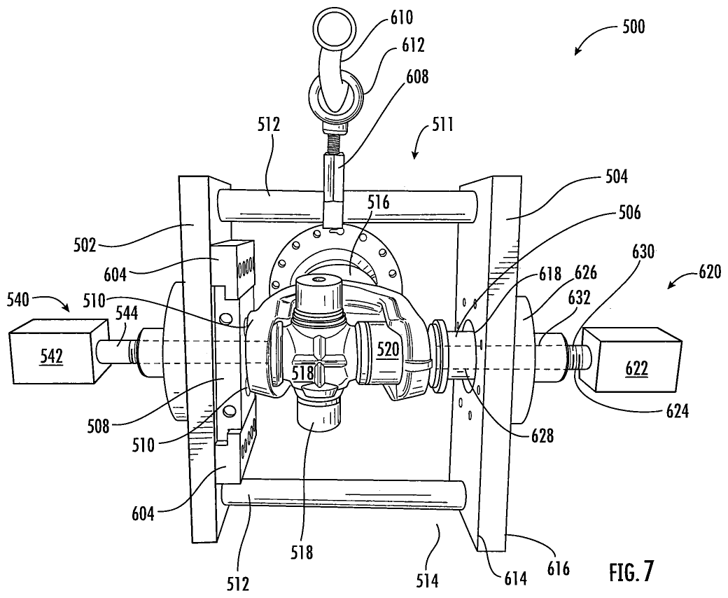

The one or hoist attachment members 608 of the joint assembly and disassembly tool 500 may be of a size and shape to be securely attached to at least a portion of a hoist (not shown). This allows the joint assembly and disassembly tool to be easily moved from one location to another when needed to assemble, disassembly and/or service a joint assembly 511. Additionally, the hoist may be utilized in order to hold the joint assembly and disassembly tool 500 in its desired position when in operation thereby taking the load off the operator making the joint assembly and disassembly tool easier to be used. As a result, this allows the joint assembly and disassembly tool 500 to be portable in nature no matter what size the joint assembly 511 being assembled, disassembled and/or serviced is. It is within the scope of this disclosure and as a non-limiting example that the at least a portion of the hoist (not shown) may be securely attached to at least a portion of the one or more hoist attachment members 608 by using a hook connection, a magnetic connection, an electro-magnetic connection, a snap-in connection, a spline connection and/or a threaded connection. In accordance with the embodiment illustrated in FIG. 7 of the disclosure and as a non-limiting example, a hook 610 of the hoist (not shown) may be securely attached to at least a portion of a ring 612 of the hoist attachment members 608.

As best seen in FIG. 7 of the disclosure and as a non-limiting example, the second part 504 of the joint assembly and disassembly tool 500 has a first side 614 and a second side 616. Extending from the first side 614 to the second side 616 of the second member 504 of the joint assembly and disassembly tool 500 is a second member aperture 618. The second member aperture 618 may be of a size and shape to receive and/or retain at least a portion of a second actuation mechanism 620. It is within the scope of this disclosure and as a non-limiting example that the second actuation mechanism 620 of the joint assembly and disassembly tool 500 may be a linear actuation mechanism, a mechanical actuation mechanism, a lead-screw actuation mechanism, a roller screw actuation mechanism, a screw jack actuation mechanism, a ball screw actuation mechanism, a linear electric actuation mechanism, a linear hydraulic actuation mechanism and/or a pneumatic linear actuation mechanism.

According to the embodiment illustrated in FIGS. 3-5, 7, 8 and 9 of the disclosure and as a non-limiting example, the second actuation mechanism 620 may include a second source of rotational power 622, a second shaft member 624, a second fixed cover 626 and the force application member 506. At least a portion of a second end portion 630 of the second shaft member 624 may be drivingly connected to at least a portion of the second source of rotational power 622 and at least a portion of a first end portion 628 of the second shaft member 624 may be drivingly connected to at least a portion of an end of the force application member 506 of the second actuation mechanism 620. Additionally, at least a portion of an intermediate portion 632 of the second shaft member 624 of the second actuation mechanism 620 may be engaged with at least a portion of the second fixed cover 626 which is integrally connected to at least a portion of the second side 616 of the second member 504 of the joint assembly and disassembly tool 500. It is therefore to be understood that the rotational power generated by the second source of rotational power 622 is translated in a linear manner to the force application member 506 through the second shaft member 624. This thrusts or plunges the force application member 506 within the second member aperture 618 toward and away from the first or second yoke arm 522 or 526 and/or the one or more bearing cup assemblies 520 within the yoke arm aperture 524 or 528 of the yoke member 516. As a result, the force application member 506 may be configured in order to apply a substantially equal amount of force onto the one or more bearing cup assemblies 520 and/or the first or second yoke arm 422 or 526 of the yoke member 516 of the joint assembly 511. It is within the scope of this disclosure and as a non-limiting example that the second fixed cover 626 may be integrally foamed as part of the second member 504 of the joint assembly and disassembly tool 500 or integrally connected to at least a portion of the second side 616 of the second member 504 by using one or more welds, one or more adhesives, one or more mechanical fasteners, a spline connection and/or a threaded connection. Additionally, it is within the scope of this disclosure and as a non-limiting example that the second source of rotational power 622 may be an electric motor, a pneumatic tool, an impact tool, a socket wrench tool, a wrench, an impactor, an impact wrench, an air wrench, an impact gun, a rattle gun, a torque gun and/or a windy gun.

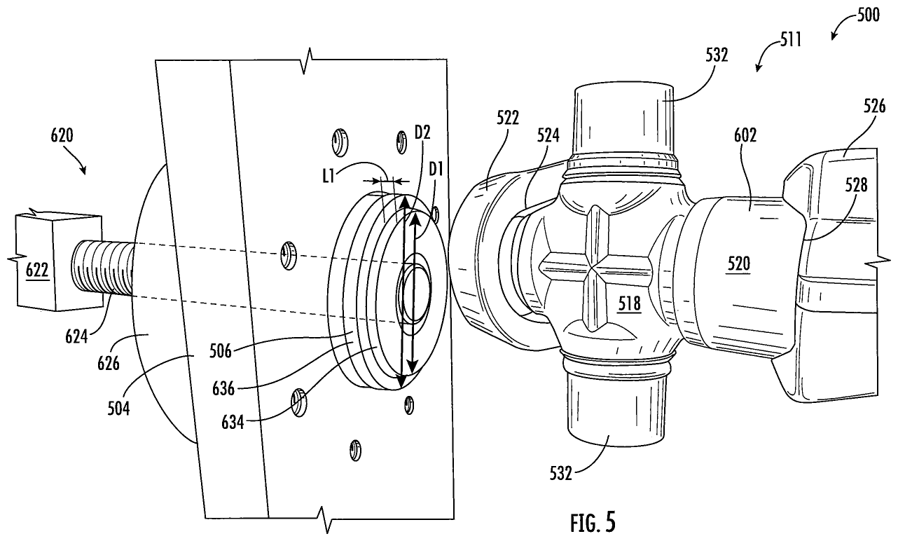

In accordance with the embodiment illustrated in FIGS. 3 and 5 of the disclosure and as a non-limiting example, the force application member 506 may include a bearing cup assembly positioning portion 634 and an increased diameter portion 636 circumferentially extending form at least a portion of a first end portion 638 of the force application member 506. As best seen in FIG. 5 of the disclosure and as a non-limiting example, the bearing cup assembly positioning portion 634 of the force application member 506 has a diameter D1 and is disposed axially outboard from and directly adjacent to at least a portion of the increased diameter portion 636 having a diameter D2. It is within the scope of this disclosure and as a non-limiting example that the diameter D1 of the bearing cup assembly positioning portion 634 of the force application member 506 may be smaller than the diameter D2 of the increased diameter portion 636 of the force application member 506.

According to an embodiment of the disclosure and as a non-limiting example, the bearing cup assembly positioning portion 634 of the force application member 506 may have a size and shape that is complementary to the size and shape of the first and second yoke arm apertures 524 and 526 of the yoke member 516 of the joint assembly 511. As a result, it is to be understood that the diameter D1 of the bearing cup assembly positioning portion 634 of the force application member 506 may be sized such that at least a portion of the bearing cup assembly positioning portion 634 may be received within at least a portion of the first or second yoke arm apertures 524 or 528 of the joint assembly 511.

As best seen in FIG. 5 of the disclosure and as a non-limiting example, the bearing cup assembly positioning portion 634 of the force application member 506 may have a length L1. The length L1 of the bearing cup assembly positioning portion 634 may be such that when the increased diameter portion 636 of the force application member 506 is in contact with the first or second yoke arm 522 or 526 of the joint assembly 511, the bearing cup assembly positioning portion 634 has driven the one or more bearing cup assemblies 520 into its ideal operating position. Additionally, the length L1 of the first increased diameter portion 624 of the force application member 506 may be such that when the increased diameter portion 636 of the force application member 506 is in contact with the first or second yoke arm 522 or 526, a snap-ring (not shown) may be installed securing the one or more bearing cup assemblies 520 within the first or second yoke arm aperture 524 or 528. It is to be understood that the force application member 506 may be modular allowing it to be used to assemble, disassemble and/or service a wide array of joint assemblies 511. As a result, the joint assembly and disassembly tool 500 may be customizable allowing it to be utilized in the assembly, disassembly and/or service of a wide array of joint assemblies 511 having varying sizes and shapes.

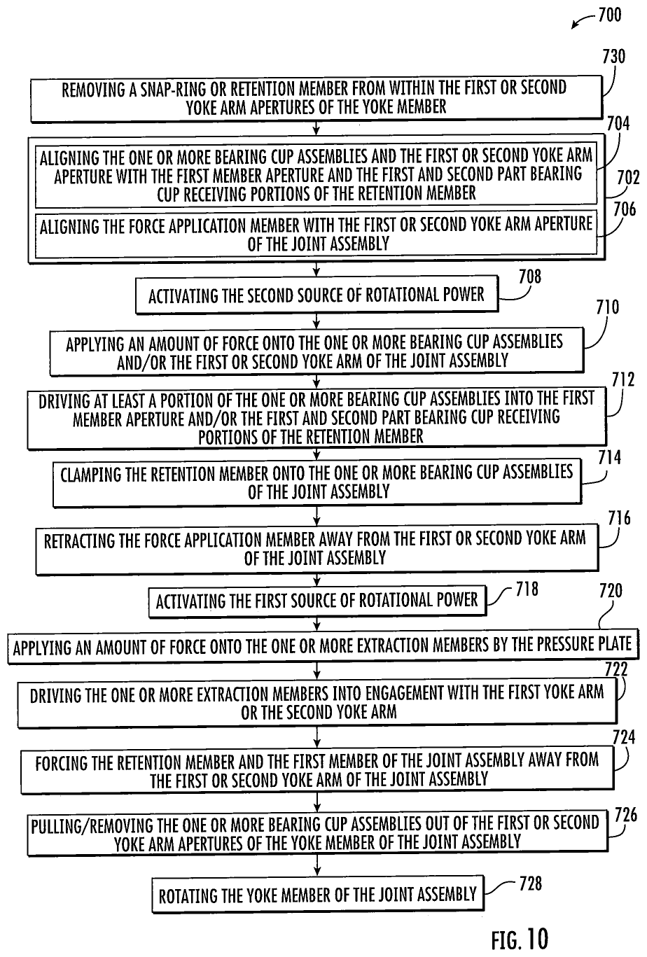

As illustrated in FIG. 10, the present disclosure further includes a method or process for disassembling 700 the joint assembly 511 described and illustrated in relation to FIGS. 3-9 of the disclosure. The method of disassembling 700 includes an alignment step 702. In the alignment step 702, there is a first alignment process 704 and a second alignment process 706. In the first alignment process 704, the one or more bearing cup assemblies 520 and/or the first or second yoke arm aperture 524 or 528 of the yoke member 516 may be aligned with the first member aperture 538 and/or the first and second part bearing cup receiving portions 572 and 592 of the retention member 508. Additionally, in the second alignment process 706 of the alignment step 702, the force application member 506 of the second actuation mechanism 620 may be aligned with the first or second yoke arm aperture 524 or 528 of the yoke member 516. It is to be understood that the first alignment step 704 and the second alignment step 706 may occur in any order.

Once the alignment step 702 has been completed, the second source of rotational power 622 o the second actuation mechanism 620 may be activated 708. The second source of rotational power 622 may be activated 708 in order to drive the force application member 506 toward the first or second yoke arm 522 or 526 of the yoke member 516 and into contact with at least a portion of the one or more bearing cup assemblies 520 of the joint assembly 511. Once the force application member 506 is in direct contact with at least a portion of the one or more bearing cup assemblies 520, the second source of rotational power 622 and the force application member 506 will apply an amount of force 710 onto the one or more bearing cup assemblies 520.

As illustrated in FIGS. 7 and 10 of the disclosure and as a non-limiting example, the force 710 applied by the second source of rotational power 622 and the force application member 506 of the second actuation mechanism 620 will drive 712 at least a portion of the one or more bearing cup assemblies 520 into at least a portion of the first member aperture 538 and/or the first and second part bearing cup receiving portions 572 and 592 of the retention member 508. Once a predetermined amount of the one or more bearing cup assemblies 520 have been received within the first and second part bearing cup receiving portions 572 and 592 of the retention member 508, the retention member 508 may be clamped 714 onto the one or more bearing cup assemblies 520.

After the retention member 508 has been clamped onto the one or more bearing cup assemblies 520, the second source of rotational power 622 may be activated in order to retract 716 the force application member 506 away from the first or second yoke arm 522 or 526 of the yoke member 516. This action will provide a gap between the force application member 506 and the first or second yoke arm 522 or 526 of the yoke member 516 allowing a bearing cup extraction process to occur.

Once the force application member 506 has been retracted 716 away from the yoke member 516, the first source of rotational power may be activated 718 driving the pressure plate 548 toward the one or more extraction members 510 of the joint assembly and disassembly tool. As best seen in FIGS. 9 and 10 of the disclosure and as a non-limiting example, once in contact with the one or more extraction members 510, the pressure plate 548 will apply an amount of force 720 onto the one or more extraction members 510 of the joint assembly and disassembly tool 500. This drives 722 the one or more extraction members 510 into engagement with the first or second yoke arm 522 or 526 thereby forcing 724 retention member 508 and first member 502 away from the first or second 522 or 526 of the yoke member 516. As a result of this process, the one or more bearing cup assemblies 520 may be pulled out of or removed from the first or second yoke arm aperture 524 or 528 in the first or second yoke arm 522 or 526 of the yoke member 516.

In accordance with the embodiment of the disclosure where the joint assembly 511 includes the use of a snap-ring (not shown) in order to retain the one or more bearing cup assemblies 520 within the first and second yoke arm apertures 524 and 528, the method may first include a snap-ring extraction or snap-ring removal step 730. This will allow the one or more bearing cup assemblies 520 to be translated into the first and second part bearing cup receiving portions 572 and 592 thereby allowing the retention member 508 to selectively engage with the one or more bearing cup assemblies 520.

After the one more bearing cup assemblies 520 have been removed, the joint assembly 511 may be rotated 728 in order to remove more of the one or more bearing cup assemblies 520 from the joint assembly 511 as needed. In order to remove one or more of the one or more bearing cup assemblies 520 from the joint assembly 511, the above-described steps may be repeated in order to remove one or more additional bearing cup assemblies 520 from the joint assembly 511.

As a result, it is to be understood that the above-described method of disassembling 700 in combination with the joint assembly and disassembly tool 500, the joint assembly 511 is able to be disassembled and/or serviced quickly and easily without negatively affecting the overall life and durability of the various components of the joint assembly 511. This allows joint assemblies that may otherwise be unserviceable to now be serviceable therefore reducing the overall amount of down time for a down vehicle and reducing the overall about of costs associated with the repair and/or replacement of the various components of the joint assembly 511.

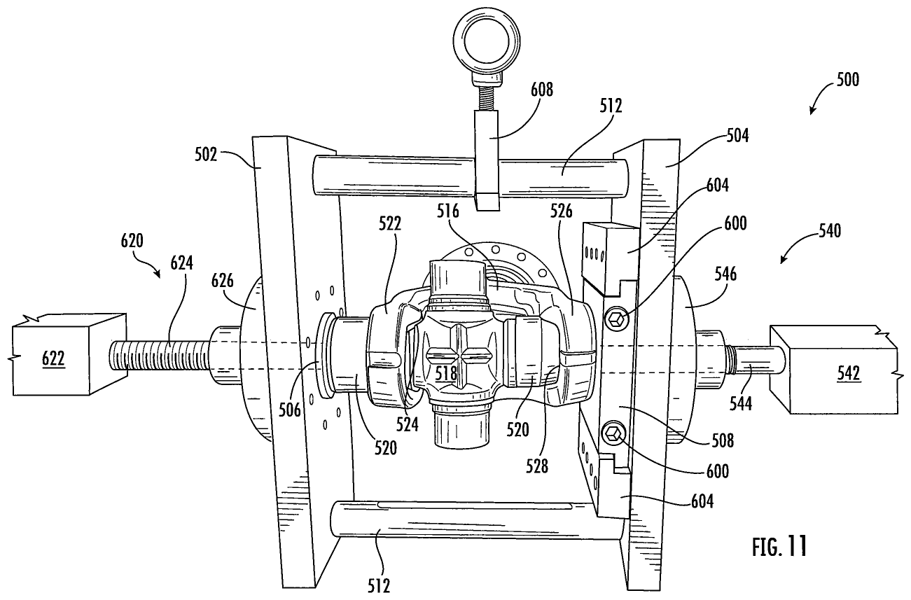

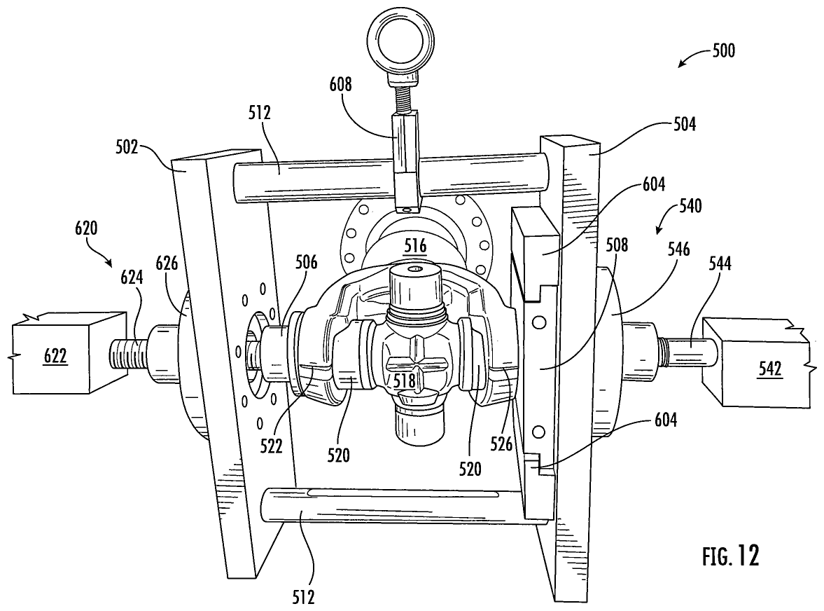

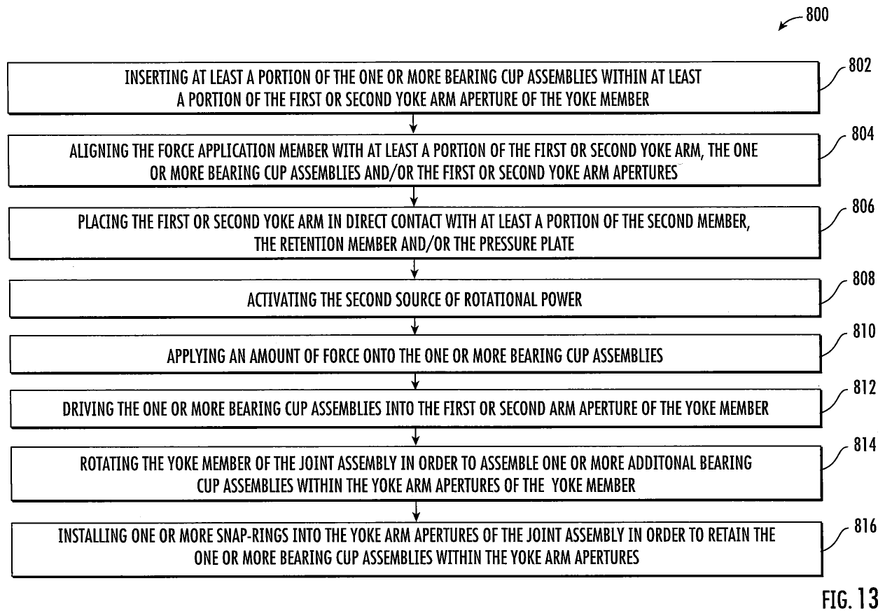

FIGS. 11 and 12 provide a schematic illustration of the joint assembly and disassembly tool 500 when engaged in an assembly process 800 for the joint assembly 511. Additionally, as illustrated in FIG. 13 provides a flow chart illustrating a method or process for assembling 800 the joint assembly 511 according to an embodiment of the disclosure. The joint assembly and disassembly tool 500 illustrated in FIGS. 11 and 12 of the disclosure is the same as the joint assembly and disassembly tool 500 described and illustrated in relation to FIGS. 3-10 of the disclosure. As a result, it is therefore to be understood that the joint assembly and disassembly tool 500 may be used in the assembly, disassembly and/or servicing of the joint assembly 511.

As best seen in FIG. 13 of the disclosure and as a non-limiting example, the assembly process 800 for the joint assembly 511 may include a step of inserting 802 at least a portion of the one or more mearing cup assemblies 520 into at least a portion of the first or second yoke arm aperture 524 or 528 of the yoke member 516. Once at least a portion of the one or more bearing cup assemblies 520 have been inserted into at least a portion of the first or second yoke arm apertures 524 or 528 of the yoke member 516, an alignment process 804 may occur. As illustrated in FIG. 11 and as a non-limiting example, during the alignment step or process, at least a portion of the force application member 506 may be aligned with the first or second yoke arm 522 or 526, the first or second yoke arm aperture 524 or 528 and/or the one or more bearing cup assemblies 520 inserted 802 within the first or second yoke arm aperture 524 or 528 of the yoke member 516 of the joint assembly 511.

The first or second yoke arm 522 or 526 of the yoke member 516 of the joint assembly 511 may then be placed in direct contact 806 with at least a portion of the second member 504 of the joint assembly and disassembly tool 500, the retention member 508, the pressure plate 548 of the first actuation mechanism 540. This provides the yoke member 516 with a rigid and/or non-moving portion surface so an amount of force may be applied to the first and/or second yoke arms 522 and/or 526 of the yoke member 511 of the joint assembly 511.

In accordance with the embodiment illustrated in FIG. 13 of the disclosure and as a non-limiting example, the assembly process 800 for the joint assembly 511 may further include a step of activating 808 the second source of rotational power 622. Once the second source of rotational power 622 has been activated 808, the force application member 506 may be driven toward the one or more bearing cup assemblies 520, the first or second yoke arm aperture 524 or 528 and/or the first or second yoke arm 522 or 526 of the joint assembly 511 until at least a portion of the force application member 506 is in direct contact with at least a portion of the one or more bearing cup assemblies 520.

After the force application member 506 has come into direct contact with at least a portion of the one or more bearing cup assemblies 520 being assembled within the joint assembly 511, the second source of rotational power 622 through the force application member 506 may continue to apply an amount of force onto the one or more bearing cup assemblies 520. As best seen in FIGS. 12 and 13 of the disclosure, this allows the second source of rotational power 622 and the force application member 506 of the joint assembly and disassembly tool 500 to drive 812 the one or more bearing cup assemblies 520 being assembled into the first or second yoke arm aperture 524 or 528 of the yoke member 516. The second source of rotational power 622 and the force application member 506 will continue to drive the one or more bearing cup assemblies 520 into the first or second yoke arm aperture 524 or 528 until the one or more bearing cup assemblies have reached their pre-determined optimal operating position within the joint assembly 511.

It is within the scope of this disclosure and as a non-limiting example that the second source of rotational power 622 and the force application member 506 may continue to drive the one or more bearing cup assemblies 520 into the first or second yoke arm aperture 524 or 528 until at least a portion of the increased diameter portion 636 of the force application member 506 is in direct contact with the first or second yoke arm 522 or 526. Once the increased diameter portion 636 of the force application member 506 is in direct contact with at least a portion of the first or second yoke arm 522 or 526 of the yoke member 516, the bearing cup assembly positioning portion 634 of the force application member 506 has driven the one or more bearing cup assemblies 520 to their ideal optimal operating position.

As best seen in FIG. 13 of the disclosure and as a non-limiting example, once the one or more bearing cup assemblies 520 have been assembled 800, the yoke member 516 and/or the joint assembly 511 may be rotated 814 in order to assemble one or more additional bearing cup assemblies 520 within the joint assembly 511. Once rotated, the above described assembly steps may be repeated in order to assemble the additional one or more bearing cup assemblies 520 into the various yoke arm apertures of the joint assembly 511.

In accordance with the embodiment of the disclosure where the one or more bearing cup assemblies 520 are retained within the yoke arm apertures using one or more snap-rings (not shown), the assembly method or process 800 may further include a snap-ring installation step 816. Once the one or more bearing cup assemblies have been driven into the first or second yoke arm aperture 524 or 528 of the yoke member 516, the one or more snap-rings or retention members (not shown) may be installed 816 within the first or second yoke arm aperture 524 or 528.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined to from the inventive concepts defined in the appended claims.

In accordance with the provisions of the patent statutes, the present invention has been described to represent what is considered to represent the preferred embodiments. However, it should be noted that this invention can be practiced in other ways than those specifically illustrated and described without departing from the spirit or scope of this invention.

What is claimed is:

1. A joint assembly and disassembly tool, comprising:
a first member having a first member aperture extending from a first side to a second side of said first member;
a second member having a second member aperture extending from a first side to a second side of said second member;
a retention member connected to at least a portion of said second side said first member;
a first actuation mechanism drivingly connected to at least a portion of a pressure plate;
wherein at least a portion of said pressure plate is received and/or retained within at least a portion of said first member aperture;
a second actuation mechanism drivingly connected to at least a portion of a force application member; and
wherein at least a portion of said force application member is selectively received within at least a portion of said second member aperture.

2. The joint assembly and disassembly tool of claim 1, wherein at least a portion of a joint assembly is interposed between said first member and said second member of said joint assembly and disassembly tool.

3. The joint assembly and disassembly tool of claim 2, wherein said joint assembly is a universal joint assembly, a U-joint assembly, a cardan joint assembly, a double cardan joint assembly, a Hooke's joint assembly, a Spicer joint assembly and/or a Hardy Spicer joint assembly.

4. The joint assembly and disassembly tool of claim 2, further comprising one or more support members;
wherein at least a portion of said one or more support portions are connected to at least a portion of said first member and said second member of said joint assembly and disassembly tool providing a gap between said first member and said second member; and
wherein at least a portion of said joint assembly is disposed within at least a portion of said gap between said first member and said second member.

5. The joint assembly and disassembly too of claim 4, further comprising one or more hoist attachment members connected to at least a portion of one or more of said one or more support members; and
wherein said one or more hoist attachment members are selectively engagable with at least a portion of a hoist.

6. The joint assembly and disassembly tool of claim 2, wherein said joint assembly comprises a yoke member having a first yoke arm with a first yoke arm aperture, a second yoke arm with a second yoke arm aperture, a journal cross and one or more bearing cup assemblies.

7. The joint assembly and disassembly tool of claim 6, wherein said retention member comprises a first part disposed directly adjacent to at least a portion of a second part;
wherein said first part of said retention member has a first side, a second side, a first end and a second end;
wherein a first part bearing cup receiving portion extends from said first side to said second side of said first part and inward into at least a portion of said first part from said second end of said first part of said retention member;
wherein said second part of said retention member has a first side, a second side, a first end and a second end;
wherein a second part bearing cup receiving portion extends from said first side to said second side of said second part and inward into at least a portion of said second part from said first end of said second part of said retention member;
wherein said first part bearing cup receiving portion and said second part bearing cup receiving portion have a size and shape needed to selectively receive and/or retain at least a portion of said one or more bearing cup assemblies of said joint assembly.

8. The joint assembly and disassembly tool of claim 7, further comprising one or more tightening members;
wherein at least a portion of said one or more tightening members are connected to at least a portion of said first part and said second part of said retention member; and
wherein said one or more tightening members are operably connected to at least a portion of said first part and said second part of said retention member in order to selectively drive said first part and said second part toward and away from said one or more bearing cup assemblies of said joint assembly.

9. The joint assembly and disassembly tool of claim 7, wherein said retention member further comprises one or more extraction members;
wherein at least a portion of said one or more extraction members are received and/or retained within at least a portion of one or more first part extraction member apertures extending from said first side to said second side of said first part and one or more first part extraction member apertures extending from said first side to said second side of said second part of said retention member;
wherein at least a portion of said pressure plate is selectively engagable with at least a portion of said one or more extraction members; and
wherein at least a portion of said one or more extraction members are selectively engagable with at least a portion of said first yoke arm or said second yoke arm of said yoke member of said joint assembly.

10. The joint assembly and disassembly tool of claim 6, wherein said pressure plate is selectively engagable with said first yoke arm, said second yoke arm and/or said one or more bearing cup assemblies of said joint assembly; and
wherein said force application member is selectively engagable with said first yoke arm, said second yoke arm and/or said one or more bearing cup assemblies of said joint assembly.

11. The joint assembly and disassembly tool of claim 1, wherein said first actuation mechanism comprises a first source of rotational power, a first shaft, a first fixed cover and said pressure plate;
wherein at least a portion of said first source of rotational power is drivingly connected to at least a portion of a first end portion of said first shaft;
wherein at least a portion of said second end portion of said first shaft is drivingly connected to at least a portion of said pressure plate; and
wherein at least a portion of an intermediate portion of said first shaft is operably connected to at least a portion of said first fixed cover in order to allow said first source of rotational power to selectively drive said pressure plate toward and away from said first yoke arm, said second yoke arm and/or said one or more bearing cup assemblies of said joint assembly.

12. The joint assembly and disassembly tool of claim 1, wherein said second actuation mechanism comprises a second source of rotational power, a second shaft, a second fixed cover and said force application member;
wherein at least a portion of said force application member is drivingly connected to at least a portion of a first end portion of said second shaft;
wherein at least a portion of said second source of rotational power is drivingly connected to at least a portion of a second end portion of said first shaft;
wherein at least a portion of an intermediate portion of said second shaft is operably connected to at least a portion of said second fixed cover in order to allow said second source of rotational power to selectively drive said force application member toward and away from said first yoke arm, said second yoke arm and/or said one or more bearing cup assemblies of said joint assembly.

13. The joint assembly and disassembly tool of claim 1, wherein said force application member comprises a bearing cup assembly positioning portion disposed directly adjacent to an increased diameter portion of said force application member;
wherein said bearing cup assembly positioning portion is of a size and shape to be received within at least a portion of said first yoke arm aperture or said second yoke arm aperture of said yoke member of said joint assembly; and
wherein said bearing cup assembly positioning portion has a length needed to drive said one or more bearing cup assemblies into said first yoke arm aperture and/or said second yoke arm aperture of said yoke member a pre-determined distance such that when at least a portion of said increased diameter portion is in direct contact with at least a portion of said first yoke arm or said second yoke arm said one or more bearing cup assemblies are in their pre-determined optimal operating positions.

14. A method of disassembling a joint assembly, comprising:
providing a joint assembly and disassembly tool comprising a first member, a second member, a retention member, a first actuation mechanism, a pressure plate, a second actuation mechanism and a force application member;
providing a first actuation mechanism having a first source of rotational power;
providing a second actuation mechanism having a second source of rotational power;
providing a joint assembly comprising a yoke member with a first yoke arm, a first yoke arm aperture, a second yoke arm, a second yoke arm aperture, a journal cross and one or more bearing cup assemblies;
activating said second source of rotational power;
applying an amount of force onto said one or more bearing cup assemblies, said first yoke arm and/or said second yoke arm with said force application member;
driving at least a portion of said one or more bearing cup assemblies into at least a portion of said retention member;
clamping said retention member onto at least a portion of said one or more bearing cup assemblies;
activating said first source of rotational power;
applying an amount of force onto one or more extraction members by said pressure plate;
driving at least a portion of said one or more extraction members into contact with at least a portion of said first yoke arm and/or said second yoke arm of said yoke member; and
forcing said one or more bearing cup assemblies out of said first yoke arm aperture or said second yoke arm aperture of said yoke member of said joint assembly.

15. The method of disassembling a joint assembly of claim 14, further comprising the step of removing one or more snap-rings or retention members from said yoke member of said joint assembly.

16. A method of assembling a joint assembly, comprising:
providing a joint assembly and disassembly tool comprising a first member, a second member, a retention member, a first actuation mechanism, a pressure plate, a second actuation mechanism and a force application member;
providing an actuation mechanism having a source of rotational power;
providing a joint assembly comprising a yoke member with a first yoke arm, a first yoke arm aperture, a second yoke arm, a second yoke arm aperture, a journal cross and one or more bearing cup assemblies;
disposing at least a portion of said joint assembly within at least a portion of said joint assembly and disassembly tool;
inserting at least a portion of said one or more bearing cup assemblies into at least a portion of said first yoke arm aperture and/or said second yoke arm aperture of said yoke member;
aligning said force application member with at least a portion of said first yoke arm, said second yoke arm, said first yoke arm aperture, said second yoke arm aperture and/or said one or more bearing cup assemblies;
activating said source of rotational power; and
driving said one or more bearing cup assemblies into said first yoke arm aperture and/or said second yoke arm aperture of said yoke member of said joint assembly.

17. The method of assembling a joint assembly of claim 16, further comprising the step of installing one or more snap-rings or retention members into said first yoke arm aperture and/or said second yoke arm aperture of said yoke member of said joint assembly.
